(19) United States
(12) Patent Application Publication
(10) Pub. No.: US 2009/0086945 A1
(43) Pub. Date: Apr. 2, 2009

(54) Methods and Apparatus for Selecting a Service Provider on a Per-Call Basis

(76) Inventors: Annette L. Buchanan, Neptune, NJ (US); Sally Ann C. Mcilhinney, Bridgewater, NJ (US); Adonny W. Raphael, Holmdel, NJ (US); Terry E. Schmalzried, Morganville, NJ (US); Brian K. Dinicola, Monroe Township, NJ (US)

Correspondence Address: Ryan, Mason & Lewis LLP, Suite 205, 1300 Post Road, Fairfield, CT, 06824, US

(21) Appl. No.: 11/862,597

(22) Filed: Sep. 27, 2007

(51) Int. Cl. H04M 3/42; H04M 15/00

(52) U.S. Cl. 379/201.02; 379/114.01; 379/211.01; 379/229

(57) ABSTRACT

Methods and apparatus are provided for selecting a service provider on a per-call basis A service provider is selected for a given call by receiving the given call from a caller; obtaining user preferences of the caller for the given call; matching the obtained user preferences to one or more capabilities of a plurality of available service providers; selecting a service provider for the given call based on the matching; and providing signaling to connect the caller and selected service provider The user preferences comprise can be default user preferences obtained from a database, preferences indicated by the caller as a part of the given call or a combination thereof Logging and report features are also disclosed

### FIELD OF THE INVENTION

The present invention relates generally to the establishment of a connection over a communications network, and more particularly, to establishing a connection over a communications network based on user preferences.

### BACKGROUND OF THE INVENTION

Communication networks transfer information, such as data, voice, text or video information, among communication devices, such as packet telephones, computer terminals, multimedia workstations, and videophones. A calling party that desires to contact a called party over a communication network typically indicates the telephone number of the called party using a dialed string that is entered using a keypad on the telephone of the calling party. The dialed string is a sequence of numbers (or symbols) that identifies the telephone of the called party on the communication network. In the United States, for example, a telephone number typically consists of ten digits (i.e., a three digit area code and a seven digit local number). The calling party (or an employer of the calling party in an enterprise environment) typically has a customer relationship with a local service provider and a long distance service provider that will deliver the call to the identified called party. In some cases, a calling party can designate a desired service provider to carry a particular call by entering a predefined dialed string, such as “*123,” with the telephone number of the called party.

In an enterprise environment, Private Branch Exchange (PBX) switches are often employed to connect the telephones within the enterprise to one another, and to connect internal users to the Public Switched Telephone Network (PSTN). A PBX can be configured by the enterprise to provide a number of features to users, such as call forwarding, voice mail and extension dialing. Typically, the features of a PBX are configured by an administrator for the entire enterprise or for various groups or departments within the enterprise.

A particular user may want more flexibility in selecting a service provider to carry a particular call. The criteria that would be evaluated by users to select a service provider, however, such as rate schedules and capabilities of the available service providers, often varies over time, and may not be publicly available Thus, a need exists for improved methods and apparatus for selecting a service provider for a given call

### SUMMARY OF THE INVENTION

Generally, methods and apparatus are provided for selecting a service provider on a per-call basis According to one aspect of the present invention, a service provider is selected for a given call by receiving the given call from a caller; obtaining user preferences of the caller for the given call; matching the obtained user preferences to one or more capabilities of a plurality of available service providers; selecting a service provider for the given call based on the matching; and providing signaling to connect the caller and selected service provider. The user preferences comprise can be default user preferences obtained from a database, preferences indicated by the caller as a part of the given call or a combination thereof. The obtained user preferences can comprise one or more of quality, security, pricing and equipment manufacturer preferences. The matching step can optionally assign a score to each of the plurality of available service providers, and then a service provider can be selected based on the score.

According to a further aspect of the invention, the disclosed centralized service broker processing center can optionally record the selected service provider and/or the indicated preferences in a log entry. In addition, the centralized service broker processing center optionally provides information, such as reports, to one or more of the plurality of available service providers based on the log entry In further variations, the centralized service broker processing center provides billing information related to the caller to the selected service provider or another merchant and can optionally authenticate the caller to the selected service provider.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram illustrating the centralized service broker processing center of FIG. 1 in further detail;

FIG. 3 is a sample table from the user profile of FIG. 2;

FIG. 4 is a sample table from the service provider database of FIG. 2; and

FIG. 5 is a flow chart describing an exemplary implementation of a service broker process incorporating features of the present invention.

### DETAILED DESCRIPTION

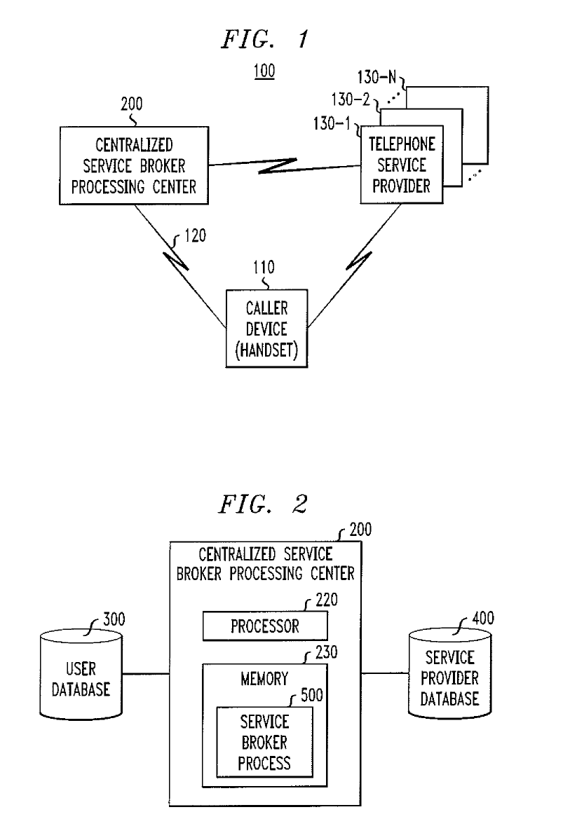

The present invention provides methods and apparatus for selecting a service provider for a given call It is noted that a service provider may provide multiple services, and in such a case, the phrase “selecting a service provider for a given call,” may require selecting a service from a service provider for a given call. FIG. 1 illustrates a network environment 100 in which the present invention can operate. As shown in FIG. 1, a calling party, employing a caller device 110, such as a telephone handset, indicates the called party (not shown) and one or more calling options. As discussed hereinafter, the calling options specified by the calling party may be based on, for example, quality, cost, network capabilities, privacy or security considerations. The called party identifier and calling options are provided over a connection 120 to a centralized service broker processing center 200, discussed further below in conjunction with FIG. 2. For example, the connection 120 can be implemented, for example, using a Session Initiation Protocol (SIP) or Voice over Internet Protocol (VoIP) connection SIP and VoIP accommodate the transmission of the user preferences (calling options) in the call setup process The centralized service broker processing center 200 evaluates the calling options and performs a matching operation to select one of a plurality of available telephone service providers 130-1 through 130-N, hereinafter collectively referred to as service providers 130 In one exemplary implementation, the specified calling options can be prioritized or weighted by the caller or by the system, so that potentially conflicting preferences, such as “lowest price” and “most secured,” can be processed in a predictable manner.

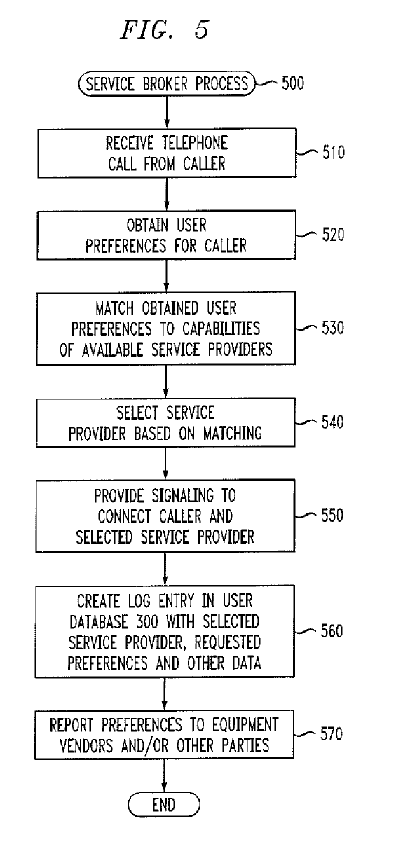

FIG. 2 is a schematic block diagram illustrating the centralized service broker processing center 200 of FIG. 1 in further detail As shown in FIG. 1, the centralized service broker processing center 200 comprises a processor 220 and a memory 230 The memory 230 configure the processor 220 to implement a service broker process 500, discussed further below in conjunction with FIG. 5. The memory 230 could be distributed or local and the processor 220 could be distributed or singular The memory 230 could be implemented as an electrical, magnetic or optical memory, or any combination of these or other types of storage devices. It should be noted that each distributed processor that makes up processor 220 generally contains its own addressable memory space

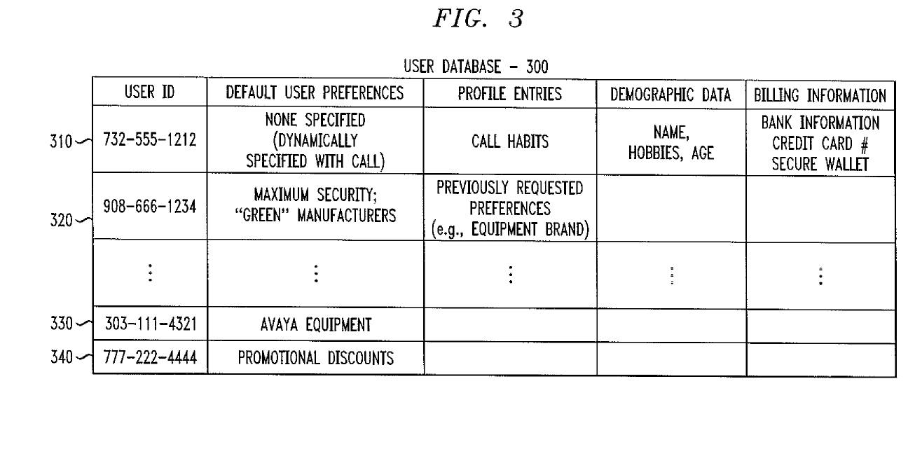

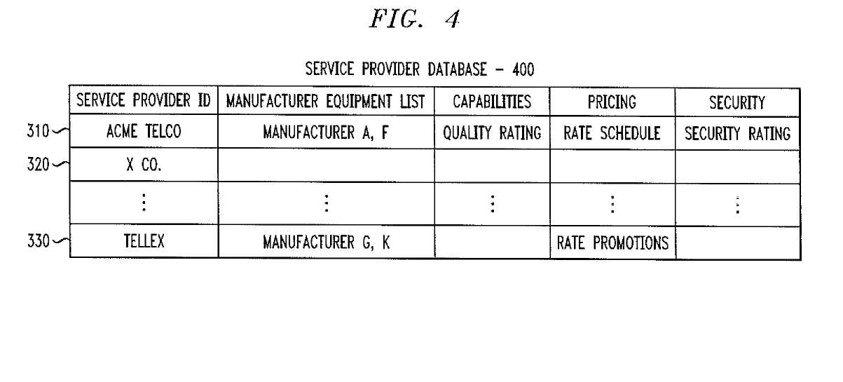

In addition, the exemplary centralized service broker processing center 200 employs external storage to store a user database 300 and a service provider database 400, discussed further below in conjunction with FIGS. 3 and 4, respectively. It is noted that the user profile 300 and/or service provider database 400 could alternatively be stored in the memory 230.

FIG. 3 is a sample table from the user profile 300 of FIG. 2 As shown in FIG. 3, the exemplary user profile 300 comprises a record for each user (calling party) For each user, the exemplary user profile 300 provides a user identifier, default user preferences, if any, profile entries, demographic data and billing information. The default user preferences may comprise, for example, one or more preferences for quality, cost, network capabilities, privacy and security. It is noted that the preferences processed by the centralized service broker processing center 200 with a given call may be obtained from the specified default preferences, dynamically indicated by the user with a given call, or a combination thereof.

In one example, the user identified in row 340 of the user profile 300 has a default preference to select a service provider offering a promotional discount for example, a service provider might offer a free or discounted call to a user in exchange for listening to an advertisement, participating in a survey or receiving promotional materials. It is noted that the service provider can offer the promotion based on a benefit from the service provider itself or a third party In a further variation, the offer associated with a given promotion can be based on the interests of a user that are known from stored demographic information and/or prior usage

It is also noted that the calling party can specify a preference for certain equipment manufacturer's that are used in the networks of the service provider For example, as shown in the user profile 300 user 320 has specified a preference for “green” manufacturers (for example, according to some predefined industry standard) Similarly, user 330 has specified a preference for service providers employing Avaya equipment in their networks In this manner, back-end equipment manufacturers, such as Avaya, can employ “powered by Avaya” promotional campaigns to increase the awareness of the general public with their products. Thus, an end user can specify a manufacturer preference, for example, by name, quality rating (e.g, four star rating), or a trade association approval

The profile entry in the user database 300 can comprise, for example, calling habits of the user (such as calling patterns), and previously requested preferences, such as manufacturer and quality preferences. These attributes can optionally be learned over time, using well-known learning techniques Such learned preferences or habits can optionally be added to the default user preferences, for example, based on predefined rules. The billing information in the user database 300 can comprise, for example, bank information, credit card information and a secure wallet Using the information in the user profile 300, the centralized service broker processing center 200 can optionally authenticate a user to a selected service provider and/or provide payment for the caller to a merchant, bank or selected service provider.

FIG. 4 is a sample table from the service provider database 400 of FIG. 2 As shown in FIG. 4, the exemplary service provider database 400 comprises a record for each service provider For each service provider, the exemplary service provider database 400 provides a service provider identifier, a network equipment list, capabilities, pricing and security information. As discussed further below in conjunction with FIG. 5, these capabilities are matched by the service broker process 500 to the indicated preferences for a given call to select an appropriate service provider for the call.

FIG. 5 is a flow chart describing an exemplary implementation of a service broker process 500 incorporating features of the present invention As shown in FIG. 5, the service broker process 500 initially receives a telephone call from a caller during step 510. The service broker process 500 obtains the user preferences for the caller during step 520. As previously indicated, the user preferences can be default preferences obtained from the user profile 300 or user preferences dynamically provided by the calling party as part of the call (or a combination thereof)

The service broker process 500 matches the obtained user preferences to capabilities of the available service providers (as recorded in the service provider database 400) during step 530. For example, each available service provider can be assigned a score based on their “closeness” to the stated user preferences. A service provider is selected for the call based on the matching during step 540. The service broker process 500 then provides the appropriate signaling or forwarding to connect the caller and the selected service provider during step 550. The user preferences can optionally be provided to the selected service provider with the call

A log entry is optionally created in the user database 300 during step 560 with the selected service provider, the requested preferences and other data. The preferences can optionally be reported, for example, to the equipment vendors, selected service provider and/or other parties during step 570 For example, the preferences can be reported with each event, as well as periodically, intermittently or upon request. A report can comprise a list of loyal customers, usage, such as a number of minutes used and other requested preferences of users In addition, the report can identify additional preferences associated with a requested preference (such as “those callers that requested Avaya equipment also wanted high security”). In this manner, equipment manufacturers can directly market their products to end users and can assess and create end-user customer demand for their products

While the figures herein show an exemplary sequence of steps, it is also an embodiment of the present invention that the sequence may be varied Various permutations of the algorithm are contemplated as alternate embodiments of the invention. In addition, while exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer Such hardware and software may be embodied within circuits implemented within an integrated circuit.

Thus, the functions of the present invention can be embodied in the form of methods and apparatuses for practicing those methods One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

As is known in the art, the methods and apparatus discussed herein may be distributed as an article of manufacture that itself comprises a computer readable medium having computer readable code means embodied thereon The computer readable program code means is operable, in conjunction with a computer system, to carry out all or some of the steps to perform the methods or create the apparatuses discussed herein. The computer readable medium may be a recordable medium (e.g, floppy disks, hard drives, compact disks, memory cards, semiconductor devices, chips, application specific integrated circuits (ASICs)) or may be a transmission medium (e g, a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network

It is to be understood that the embodiments and variations shown and described herein are merely illustrative of the principles of this invention and that various modifications may be implemented by those skilled in the art without departing from the scope and spirit of the invention

What is claimed is:

1. A method for selecting a service provider for a given call, comprising the steps of:
receiving said given call from a caller;
obtaining user preferences of said caller for said given call;
matching said obtained user preferences to one or more capabilities of a plurality of available service providers;
selecting a service provider for said given call based on said matching; and
providing signaling to connect said caller and selected service provider

2. The method of claim 1, wherein said user preferences comprise one or more default user preferences obtained from a database

3. The method of claim 1, wherein said user preferences comprise one or more preferences indicated by said caller as a part of said given call.

4. The method of claim 1, wherein said matching step further comprises the step of assigning a score to each of said plurality of available service providers

5. The method of claim 4, wherein said selecting step further comprises the step of selecting a service provider from said plurality of available service providers based on said score

6. The method of claim 1, wherein said step of providing signaling further comprises the step of routing said given call to said selected service provider.

7. The method of claim 1, wherein said obtained user preferences comprise one or more of quality, security, pricing and equipment manufacturer preferences

8. The method of claim 1, wherein said obtained user preferences comprise a preference to select a service provider offering a promotion

9. The method of claim 1, further comprising the step of creating a log entry of one or more of said obtained user preferences.

10. The method of claim 9, further comprising the step of recording said selected service provider in said log entry

11. The method of claim 9, further comprising the step of providing information to one or more of said plurality of available service providers based on said log entry.

12. The method of claim 1, further comprising the step of providing billing information related to said caller to said selected service provider or another entity.

13. The method of claim 1, further comprising the step of authenticating said caller to said selected service provider or another entity.

14. A system for selecting a service provider for a given call, comprising:
a memory; and
at least one processor, coupled to the memory, operative to:
receive said given call from a caller;
obtain user preferences of said caller for said given call;
match said obtained user preferences to one or more capabilities of a plurality of available service providers;
select a service provider for said given call based on said matching; and
provide signaling to connect said caller and selected service provider.

15. The system of claim 14, wherein said user preferences comprise one or more of default user preferences obtained from a database and preferences indicated by said caller as a part of said given call.

16. The system of claim 14, wherein said processor is further configured to assign a score to each of said plurality of available service providers and select said service provider from said plurality of available service providers based on said score.

17. The system of claim 14, wherein said processor is further configured to route said given call to said selected service provider.

18. The system of claim 14, wherein said obtained user preferences comprise one or more of quality, security, pricing and equipment manufacturer preferences.

19. The system of claim 14, wherein said obtained user preferences comprise a preference to select a service provider offering a promotion.

20. The system of claim 14, wherein said processor is further configured to create a log entry of one or more of said obtained user preferences.

21. The system of claim 20, wherein said processor is further configured to record said selected service provider in said log entry.

22. The system of claim 20, wherein said processor is further configured to provide information to one or more of said plurality of available service providers based on said log entry.

23. The system of claim 14, wherein said processor is further configured to provide billing information related to said caller to said selected service provider or another entity

24. The system of claim 14, wherein said processor is further configured to authenticate said caller to said selected service provider or another entity

25. An article of manufacture for selecting a service provider for a given call, comprising a machine readable medium containing one or more programs which when executed implement the steps of:
receiving said given call from a caller;
obtaining user preferences of said caller for said given call;
matching said obtained user preferences to one or more capabilities of a plurality of available service providers;
selecting a service provider for said given call based on said matching; and
providing signaling to connect said caller and selected service provider
